(19) United States
(12) Patent Application Publication
(10) Pub. No.: US 2018/0100469 A1
(43) Pub. Date: Apr. 12, 2018

(54) Dual Fuel Ammonia Combustion in Diesel Engines

(71) Applicant: Sturman Digital Systems, LLC, Woodland Park, CO (US)

(72) Inventor: Oded Eddie Sturman, Woodland Park, CO (US)

(21) Appl. No.: 15/834,349

(22) Filed: Dec. 7, 2017

Related U.S. Application Data
(63) Continuation of application No. PCT/US2016/036766, filed on Jun. 9, 2016.
(60) Provisional application No. 62/173,585, filed on Jun. 10, 2015.

(51) Int. Cl. F02M 25/00; F01N 3/20; B01D 53/94

(52) U.S. Cl. CPC F02M 25/00; B01D 53/9418; F01N 3/2066

(57) ABSTRACT

A method of reducing NOₓ in the exhaust of a diesel engine having at least one combustion chamber by introducing NH₃ into the diesel engine prior to a combustion event, at least some of the NH₃ injected reducing the amount of NOₓ in the exhaust of the diesel engine, whereby the exhaust will contain an amount of NOₓ that is less than if no injection of NH₃ was used, and will also contain an amount of NH₃ that is less than the amount injected into the diesel engine, the rest of the NH₃ being consumed during the combustion event and the reduction of NH₃.

### CROSS-REFERENCE TO RELATED APPLICATIONS

This application is a continuation of International Application No. PCT/US2016/036766 filed Jun. 9, 2016 which claims the benefit of U.S. Provisional Patent Application No. 62/173,585 filed Jun. 10, 2015.

### BACKGROUND OF THE INVENTION

### 1. Field of the Invention

The present invention relates to the field of diesel engines.

### 2. Prior Art

Diesel engines running on diesel fuels and biodiesel fuels are, of course, well known in the prior art. Historically, they are also well known for their emissions. In very recent years, the emissions of diesel engines in both hydrocarbons and NOₓ have been substantially reduced. However, the environmental controls have been reduced faster than the actual emissions of a diesel engine, and accordingly, a urea after treatment of the exhaust has been adopted. However, the after treatment apparatus is quite expensive and can cost a substantial fraction of the engine cost itself. There is a need for a less expensive system for reducing NOₓ below the levels of the best diesel engines now on the road, and probably further out into the future.

### BRIEF DESCRIPTION OF THE DRAWINGS

FIG. 1 is an exemplary engine incorporating the present invention.

FIG. 2 is another exemplary engine incorporating the present invention.

FIG. 3 is an exemplary operating cycle for the engine of FIG. 2.

FIG. 4 is still another exemplary engine incorporating the present invention.

### DETAILED DESCRIPTION OF THE PREFERRED EMBODIMENTS

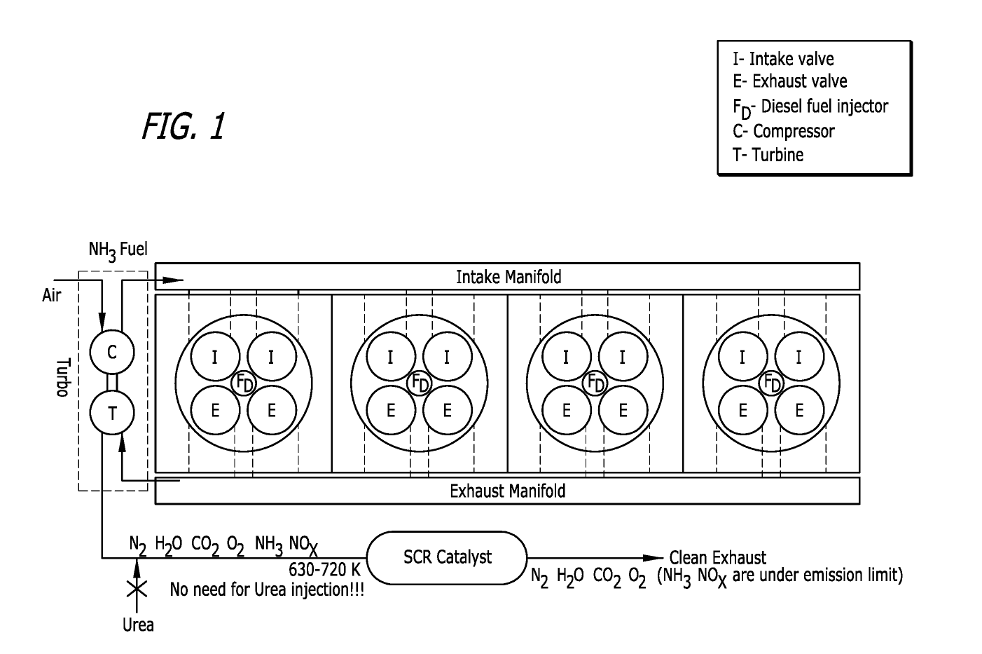

First referring to FIG. 1, an engine configuration in accordance with the present invention may be seen. The engine block, itself, is conventional and may, in fact, be a preexisting engine block, crankshaft, pistons, etc., as is well known in the prior art. Each cylinder in this exemplary engine has a pair of intake valves I, a pair of exhaust valves E, and a diesel fuel injector FD. The engine also has an intake manifold and exhaust manifold, the particular engine shown including an exhaust turbine T driving a compressor C for turbocharging the intake manifold. Air, of course, is brought into the air intake of the turbocharger and delivered to the intake manifold, with the exhaust being coupled to the turbo T of the turbocharger and then being emitted therefrom. In addition, however, an amount of ammonia, NH₃, is also provided to the intake manifold in a quantity closely controlled in response to the engine operating conditions at the time the NH₃ is provided to the intake manifold. The ammonia is partially consumed in the combustion, but if the proper amount controlled based on engine operating conditions, the exhaust will contain a controlled amount of ammonia. Thus the output of the engine will contain N₂, H₂O, CO₂, O₂, NH₃ and NOₓ. This is coupled to the SCR catalyst (selective catalytic reduction) for selective catalytic reduction of the NOₓ remaining in the exhaust. Catalysts are well known for reducing NOₓ and NH₃ to N₂ and H₂O, and actually the same catalyst can be used as is used for urea injection in the exhaust. The output of the SCR catalyst unit will contain N₂, H₂O, CO₂ and O₂, with trace amounts of NH₃ and NOₓ, both under the emission limit. In general, the lower the NOₓ that would be generated by the engine without the NH₃ injection, the lower the NOₓ content in the output of the SCR catalyst.

The engine shown in FIG. 1, as noted before, may be a conventional 4-stroke engine (though the present invention would also be applicable to 2-stroke engines) running on diesel or biodiesel fuel. The engine shown may also be a camless engine using electronically controlled hydraulic valve actuators such as U.S. Pat. Nos. 5,638,781, 5,713,316, 5,960,753, 5,970,956, 6,148,778, 6,173,685, 6,308,690, 6,360,728, 6,415,749, 6,557,506, 6,575,126, 6,739,293, 7,025,326, 7,032,574, 7,182,068, 7,341,028, 7,387,095, 7,568,633 7,730,858, 8,342,153 and 8,629,745, and U.S. Patent Application Publication No. 2007/0113906. These patents and patent applications disclose hydraulic valve actuation systems primarily intended for engine valves such as but not limited to intake and exhaust valves, and include, among other things, methods and apparatus for control of engine valve acceleration and deceleration at the limits of engine valve travel as well as variable valve lift. Similarly, the fuel injector FD may be, by way of example, intensifier type fuel injectors electronically controlled through spool valves of the general type disclosed in one or more of U.S. Pat. Nos. 5,460,329, 5,720,261, 5,829,396, 5,954,030, 6,012,644, 6,085,991, 6,161,770, 6,257,499, 7,032,574, 7,108,200, 7,182,068, 7,412,969, 7,568,632, 7,568,633, 7,694,891, 7,717,359, 8,196,844, 8,282,020, 8,342,153, 8,366,018, 8,579,207, 8,628,031 and 8,733,671, and U.S. Patent Application Publication Nos. 2002/0017573, 2006/0192028, 2007/0007362, 2010/0012745, and 2014/0138454. These patents and patent applications disclose electronically controllable intensifier type fuel injectors having various configurations, and include direct needle control, variable intensification ratio, intensified fuel storage and various other features.

Thus, in accordance with this embodiment of the present invention, no urea is used, and further, no injection of any kind into the exhaust stream is used. Instead, the NH₃ serves the purpose of the urea and may start the reduction of NOₓ in the final portions of the power stroke of the engine. In fact, such NOₓ reduction may, in some instances, make the SCR element unneeded.

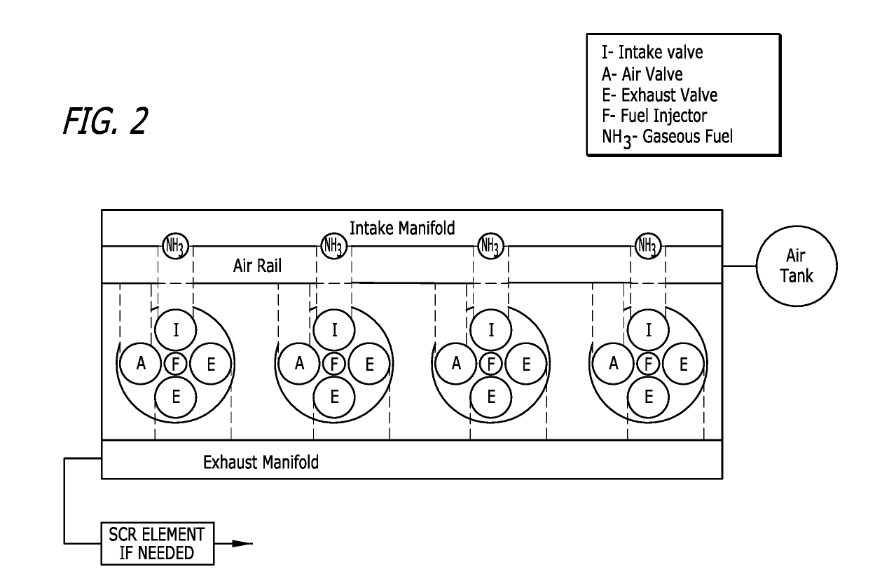

Now referring to FIG. 2, a different form of diesel engine may be seen. This engine includes, of course, an intake manifold I and an exhaust manifold E, but further includes an air rail and air tank (TANK). Each cylinder has a fuel injector F, an intake valve I coupled to the intake manifold I, two exhaust valves E coupled to the exhaust manifold E, and an air valve A coupled to the air rail A. Also, associated with each intake valve is an ammonia injector, so that controlled amounts of ammonia may be provided to the intake of the engine. In that regard, while separate ammonia injectors are shown for each cylinder, other arrangements for the ammonia injectors may readily be incorporated.

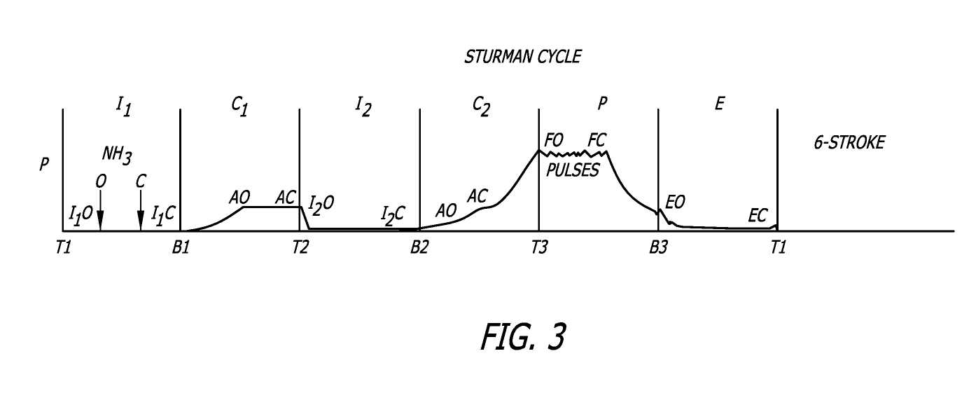

Now referring to FIG. 3, an exemplary operating cycle for the engine of FIG. 2 may be seen. In this Figure, top dead piston positions are labeled T and bottom dead center piston positions are labeled B. As shown in this Figure, at or near a top dead center position T1, the intake valve I is opened (I₁O) and somewhere during the intake stroke between T1 and B1, NH₃ is injected into the intake for the respective cylinder (NH₃O), and later before bottom dead center position B1, the NH₃ injection ceases (NH₃C). Also at or near the bottom dead center position B1 the intake valve is closed (I₁C), and during the compression stroke between B1 and T2 the air taken in between T1 and B1 is somewhat compressed and then the air valve for the respective cylinder is opened (AO) and then closed (AC) at or near the top dead center position T2 to maintain a pressure in the air rail A. Also, the intake valve is again opened (I₂O) and another charge of air is taken in between T2 and B2, at or near which point the intake valve I is closed (IC). Early in the compression stroke between B2 and T3, the air valve A is opened (AO) and then closed (AC) to receive in the combustion chamber of the engine the air taken in between T1 and B1 to add to that taken in between T2 and B2. Then starting at top dead center T3 the diesel injector F (FIG. 2) is pulsed a number of times to initiate combustion and to control the temperature in the combustion chamber, to extend combustion over a larger crankshaft angle and to break up the boundary layer that otherwise would build up around continuously injected fuel. Finally at the end of the power stroke at B3 the exhaust valve is opened (EO) and then at the end of the exhaust stroke the exhaust valve is closed (EC) and the cycle repeats at T1 again.

Accordingly, in accordance with this embodiment of the present invention, a 6-stroke cycle is used, in essence, to provide nearly double compression, and thus much higher pressures and temperatures of compression than achievable in a common 4-stroke engines may be reached to result in self-ignition of the NH₃ if desired. Again, of course, the amount of NH₃ injected is controlled in accordance with the engine operating conditions for reduction of the NOₓ generated in the engine, the reduction occurring during at least part of the power stroke and in the exhaust system. Again, of course, as shown in FIG. 2, if desired, an SCR element may be used if required. The cycle of FIG. 3 is, of course, highly schematic and exemplary only, as one could also operate on an 8-stroke cycle, if desired.

Again, the reduction of NOₓ in the exhaust is accomplished by controlling the amount of NH₃ injected in the intake of each cylinder, with no injection of anything in the exhaust and no injection of urea anywhere.

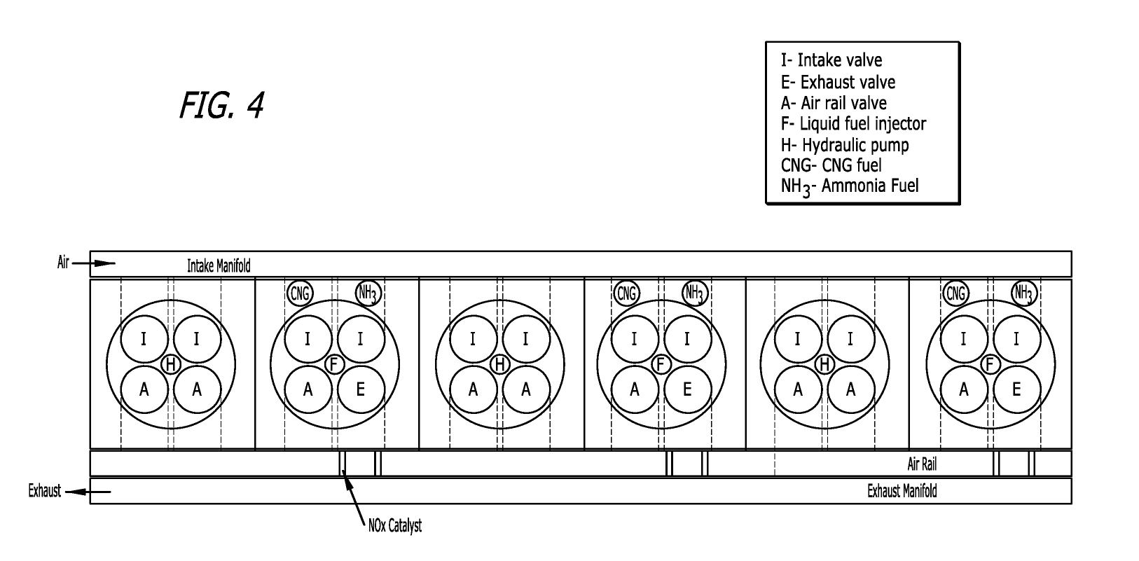

Now referring to FIG. 4, a still further embodiment of the present invention may be seen. This exemplary embodiment is a six cylinder engine with three cylinders dedicated to intake air compression and three cylinders dedicated to combustion or power cylinders. Starting from the left, the first, third and fifth cylinders are used for air compression and the second, fourth and sixth cylinders for combustion. The compression cylinders have two intake valves I coupled to the intake manifold and two air valves A coupled to the air rail. Also in these cylinders is a hydraulic pump H riding on top of the piston and used to pump hydraulic fluid, typically engine oil, for use as an actuating fluid for hydraulic valve actuators and to power the intensifiers in the fuel injectors F. The combustion cylinders also have two intake valves I, but only one air valve A, coupled to the air rail, with an exhaust valve E coupled to the exhaust, in this embodiment through an optional catalyst defining the passage through the air rail to the exhaust manifold. Also, between the intake manifold and one intake valve I is a compressed natural gas (CNG) injector, and on the other intake valve I is the NH₃ injector.

In operation, the compression cylinders act in a 2-stroke cycle, whereas the combustion cylinders act in a 4-stroke cycle. Accordingly, the operation of the engine is somewhat similar to that of FIG. 3, though the compression between T1 and T2 is actually done twice in a compression cylinder for each combustion cycle. During the intake stroke of the combustion cylinders of FIG. 4 (between T2 and B2 of FIG. 3), NH₃ is injected into the intake, then, like in FIG. 3 (between B2 and T3), air valves A are opened to receive pressurized air from the air rail, then closed so that the total charge in the combustion cylinders will be, in essence, three times that of a normal engine. Then, like in FIG. 3, at or near top dead center, fuel, typically diesel fuel or biodiesel fuel, is injected using a plurality of injection pulses, with the power stroke following and then a conventional exhaust stroke through the exhaust manifold. In the embodiment shown, the coupling through the air rail to the exhaust valve is using the NOₓ catalyst, as previously mentioned, though the NOₓ catalyst may instead or also be used in the exhaust manifold itself, or in some cases, may not be needed at all. As an option, compressed natural gas (CNG) may also be injected into the intake, like the NH₃ and used as an additional fuel. For light engine loads, the diesel injection may only be used for initiation of combustion, with the power coming from the combustion of the CNG, and whatever NH₃ is consumed.

Again, as in the earlier embodiments, the NH₃ remaining after combustion reduces most of the NOₓ generated without any injection of anything in the exhaust manifold and without any use of urea. Thus the engine is ammonia fuel fumigated and has the ability to include the injection of compressed natural gas fuel. Ignition is caused by a small pilot diesel injection to initiate combustion, followed by further pulses of fuel as required for the power setting. The presence of residual ammonia eliminates the need for urea injection, with the NOₓ catalyst being an optional after treatment, if needed.

The engines illustrated and the operating cycles thereof are merely exemplary and highly schematic only. Thus the present invention has a number of aspects, which aspects may be practiced alone or in various combinations or sub-combinations, as desired. Also while certain preferred embodiments of the present invention have been disclosed and described herein for purposes of exemplary illustration and not for purposes of limitation, it will be understood by those skilled in the art that various changes in form and detail may be made therein without departing from the spirit and scope of the invention.

What is claimed is:

1. A method of reducing NOₓ in the exhaust of a diesel engine having at least one combustion chamber comprising:
introducing a controlled quantity of NH₃ into the diesel engine prior to a combustion event;
at least some of the NH₃ injected reducing the amount of NOₓ in the exhaust of the diesel engine, whereby the exhaust will contain an amount of NOₓ that is less than if no injection of NH₃ was used, and will also contain an amount of NH₃ that is less than the amount injected into the diesel engine, the rest of the NH₃ being consumed during the combustion event and the reduction of NH₃.

2. The method of claim 1 wherein the NH₃ is introduced into the diesel engine through engine air intake valves of the diesel engine.

3. The method of claim 1 wherein the NH₃ is introduced into the diesel engine through an air intake manifold of the diesel engine.

4. The method of claim 1 wherein the exhaust will also contain N₂, H₂O, CO₂ and O₂.

5. The method of claim 1 wherein the exhaust of the diesel engine is also passed through an NOₓ catalyst for further NOₓ reduction.

6. The method of claim 1 wherein the exhaust of the diesel engine is also passed through an NOₓ catalyst in or between an exhaust manifold and the diesel engine for further NOₓ reduction.

7. A method of reducing NOₓ in the exhaust of a diesel engine having at least one combustion chamber comprising:
introducing a controlled quantity of NH₃ into the diesel engine prior through an air intake manifold of the diesel engine through an air intake manifold of the diesel engine to a combustion event;
at least some of the NH₃ injected reducing the amount of NOₓ in the exhaust of the diesel engine, whereby the exhaust will contain an amount of NOₓ that is less than if no injection of NH₃ was used, and will also contain an amount of NH₃ that is less than the amount injected into the diesel engine, the rest of the NH₃ being consumed during the combustion event and the reduction of NH₃; and wherein
the exhaust of the diesel engine is also passed through an NOₓ catalyst for further NOₓ reduction.

8. The method of claim 7 wherein the NH₃ is introduced into the diesel engine through an air intake manifold of the diesel engine.

9. The method of claim 7 wherein the exhaust will also contain N₂, H₂O, CO₂ and O₂.

10. The method of claim 7 wherein the NOₓ catalyst is in or between an exhaust manifold and the diesel engine.
